(19) United States
(12) Patent Application Publication
(10) Pub. No.: US 2026/0368198 A1
(43) Pub. Date: Nov. 19, 2026

(54) GENERATIVE ARTIFICIAL INTELLIGENCE-BASED CONVERSION OF DATA STAGE FILES

(71) Applicant: ACCENTURE GLOBAL SOLUTIONS LIMITED, Dublin 4 (IE)

(72) Inventors: Subhashini Lakshminarayanan, Chennai (IN); Yashwanth Reddy Duggireddy, Nellore (IN); Ritika Kandhari, Amritsar (IN); Preeti Sharma, Sydney (AU); Shailesh Pradip Chaphekar, Mumbai (IN); Gopali Raval Contractor, Mumbai (IN); Mukesh Kumar Chaudhary, Bangalore (IN)

(73) Assignee: ACCENTURE GLOBAL SOLUTIONS LIMITED, Dublin 4 (IE)

(21) Appl. No.: 19/209,434

(22) Filed: May 15, 2025

(51) Int. Cl. G06F 16/25; G06F 16/2452; G06F 16/2458

(52) U.S. Cl. CPC G06F 16/254; G06F 16/24522; G06F 16/2465

(57) ABSTRACT

A system and method for generative artificial intelligence-based conversion of data stage files is disclosed. The system receives data stage files including stages of multiple stage types. The stage represents a specific operation in an extract, transform, load (ETL) process. The system generates stage clusters corresponding to the stages and then aggregates subset(s) of the stages in the received data stage file corresponding to a transformation stage type of the multiple stage types. The system generates logical flow including input links and output links between the subset of the stages. Thereafter, the system generates a stage graph representing the logical flow. Further, the system optimizes the stage graph by clustering the nodes based on predetermined factors. Consequently, the system generates instructions converted to a target language by providing the optimized stage graph as a prompt to a Large Language Model (LLM).

### TECHNICAL FIELD

Various examples described herein relate generally to generative artificial intelligence (GenAI)-based conversion of data stage files. Specifically, the disclosed examples are directed to conversion of the data stage files to the target language using GenAI, machine learning (ML) and deep learning (DL) techniques.

### BACKGROUND

Data stage provides a robust platform for the acquisition, transformation, validation, and loading of substantial data volumes, thereby enabling organizations to effectively address the complexities of data and advanced analytics. Its graphical interface and extensive library of pre-built functions simplify the process of creating data integration solutions, making it a preferred choice for organizations aiming to improve data accessibility, quality, and insights across diverse data landscapes. Further, the data stage facilitates the creation of data integration solutions aiming to enhance data accessibility, data quality, and the generation of insights from heterogeneous data sources. The data stage file conversion using generative artificial intelligence (GenAI) specifically refers to the application of artificial intelligence (AI) methodologies to automate or semi-automate the translation, refactoring, or conversion of legacy instructions into contemporary programming languages or frameworks during data and system migration initiatives.

### SUMMARY

Implementations of the present disclosure are generally directed to conversion of a data stage file to a target language. More particularly, implementations of the present disclosure are directed to conversion of the data stage file to the target language using GenAI, machine learning (ML) and deep learning (DL) techniques.

In general, innovative aspects of the subject matter described herein provide a system and a method for conversion of data stage files using GenAI, ML and DL techniques. The system may include one or more hardware processors. The system may further include one or more non-transitory processor-readable medium storing instructions to be executed by the one or more hardware processors. The system may receive data stage file regarding a process including a plurality of stages of multiple stage types. Herein a stage of the plurality of stages may represent a specific operation in an extract, transform, load (ETL) process. Further, the system may generate, using a plurality of entities output by a foundation model, stage clusters corresponding to the plurality of stages. The plurality of entities may be the output by the foundation model in response to receiving the received data stage file as input. Further, the system may aggregate one or more subsets of the plurality of stages in the received data stage file, from the stage clusters, corresponding to a transformation stage type of the multiple stage types. The system may generate, by using a data mining model, logical flow including input links and output links between the one or more subsets of the plurality of stages. Herein, the data mining model may provide the output in response to receiving the one or more subset of the plurality of stages as input. Moreover, the system may generate a stage graph representing the logical flow. The nodes of the stage graph may represent corresponding stages of the plurality of stages and edges of the stage graph connecting the nodes may represent the input links and output links. The system may optimize the stage graph by clustering the nodes based on predetermined factors. Consequently, the system may generate instructions converted to a target language by providing the optimized stage graph as a prompt to a Large Language Model (LLM).

The present disclosure further describes a method for implementing the system provided herein. The present disclosure also describes non-transitory processor-readable storage medium coupled to one or more hardware processors and having instructions stored thereon which, when executed by the one or more hardware processors, cause the one or more hardware processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the provided aspects and features.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment used to execute implementations of the present disclosure.

FIG. 2 illustrates an example architecture of a back-end system for GenAI-based conversion of a data stage file, in accordance with implementations of the present disclosure.

FIG. 3 illustrates a block diagram representation of a stage segmentation module for generating stage clusters corresponding to a plurality of stages in the data stage file, in accordance with implementations of the present disclosure.

FIG. 4 illustrates a block diagram representation of a dependency mapping module for generating logical flow between a subset of the plurality of stages in the data stage file, in accordance with implementations of the present disclosure.

FIG. 5 illustrates a block diagram representation of a graph generation module for generating a stage graph representing the logical flow in the data stage file, in accordance with implementations of the present disclosure.

FIG. 6 illustrates a block diagram representation of a stage optimization module for optimizing the stage graph, in accordance with implementations of the present disclosure.

FIG. 7 illustrates a flow diagram of an example processor-executable method for GenAI-based conversion of a data stage file, in accordance with implementations of the present disclosure.

FIG. 8 illustrates a computer system that may be used to implement the back-end system disclosed in the example environment of FIG. 1 for GenAI-based conversion of a data stage file, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

The “data stage file(s)” refers to file representing a specific stage or step in a data integration job. Essentially, the data stage file(s) defines the data movement and manipulation in the system.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specifications and drawings are to be regarded in an illustrative rather than a restrictive sense. It will, however, be evident that various modifications and changes may be made thereunto without departing from the broader spirit and scope of the invention as set forth in the claims.

Data stage enables the design, development, and execution of data integration jobs for data movement and transformation. Fundamentally, the data stage supports both extract, transform, load (ETL) and extract, load, transform (ELT) paradigms. Currently, during data migration scenarios involving a data stage, there is a lack of automated methodologies for the direct translation of data stage job definitions in the data stage files into target execution languages such as Spark SQL or PySpark. In the traditional method, data stage file conversion into target language remains a manual process. The inherent complexity of data stage file specifications, unlike conventional programming languages, stems from its structural composition, encompassing job stages and directed links representing data flow between these stages. Stages encapsulate various data processing operators, including transformers, aggregators, join operations (inner, outer, lookup), aggregations, conditional expressions, and filtering logic. Consequently, a data stage file encapsulates metadata, job topology, configuration parameters, and connection definitions. This complexity often leads to non-linear workflow designs with the introduction of alternate or parallel execution paths, resulting in non-sequential and loosely coupled code segments. Furthermore, transformation logic is typically externalized from individual stage block definitions. Additionally, the traditional methods exhibit limitations in handling nested query structures and lack the capability to generate optimized instructions partitions.

The proposed solution addresses these limitations by decomposing data stage files into discrete entities and providing a simplified, graph-based representation. This abstraction facilitates the translation or conversion of data stage files into arbitrary target languages. The graphical representation provides an advantage in optimizing the generated instructions, leading to enhanced execution performance and reduced memory footprint.

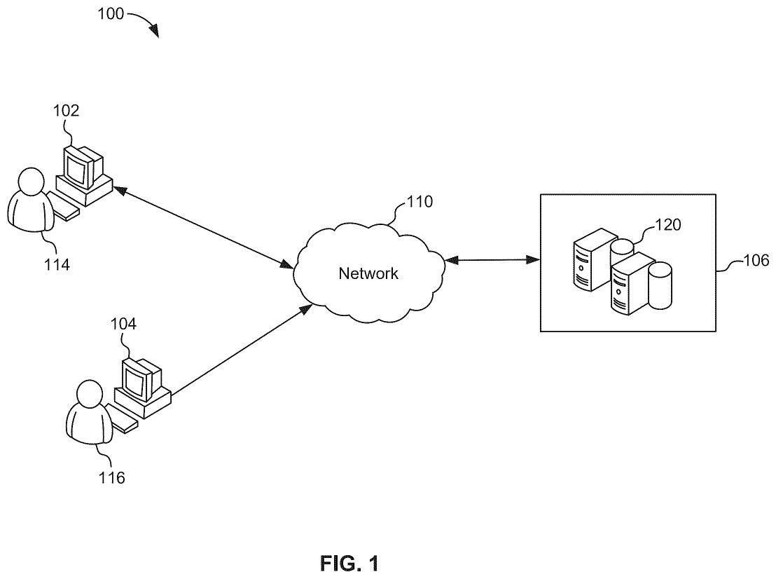

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, a back-end system 106, and a network 110. In some examples, the computing devices 102 and 104 are used by respective users 114 and 116 to log into and interact with the back-end system 106 and applications executing on the back-end system 106 according to implementations of the present disclosure.

As shown in FIG. 1, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing devices 102, 104), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end systems 106 includes at least one server system 120. In some examples, the server system 120 hosts one or more computer implemented services that users 114 and/or 116 can interact with by using the computing devices 102 and/or 104, respectively. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third party on behalf of an enterprise.

In some examples, the computing devices 102 and 104 each include computer executable applications executed thereon. In some examples, the computing devices 102 and 104 each include a web browser application executed thereon, which can be used to display one or more web pages of applications executing on the back-end system 106. In some examples, each of the computing devices 102 and 104 can display one or more GUIs that enable the respective users 114 and 116 to interact with the back-end system 106. In accordance with implementations of the present disclosure, the back-end system 106 may host enterprise applications or systems that require data sharing and data privacy. In some examples, the computing device 102 and/or the computing device 104 can communicate with the back-end system 106 over the network 110.

In some implementations, the back-end system 106 can be implemented in a cloud environment. The back-end system 106 includes at least one server system (or server) 120. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used for generative artificial intelligence (GenAI)-based conversion of a data stage file to a target language. Various examples, depicting GenAI-based conversion of the data stage file to the target language, are described in detail in conjunctions with figures below.

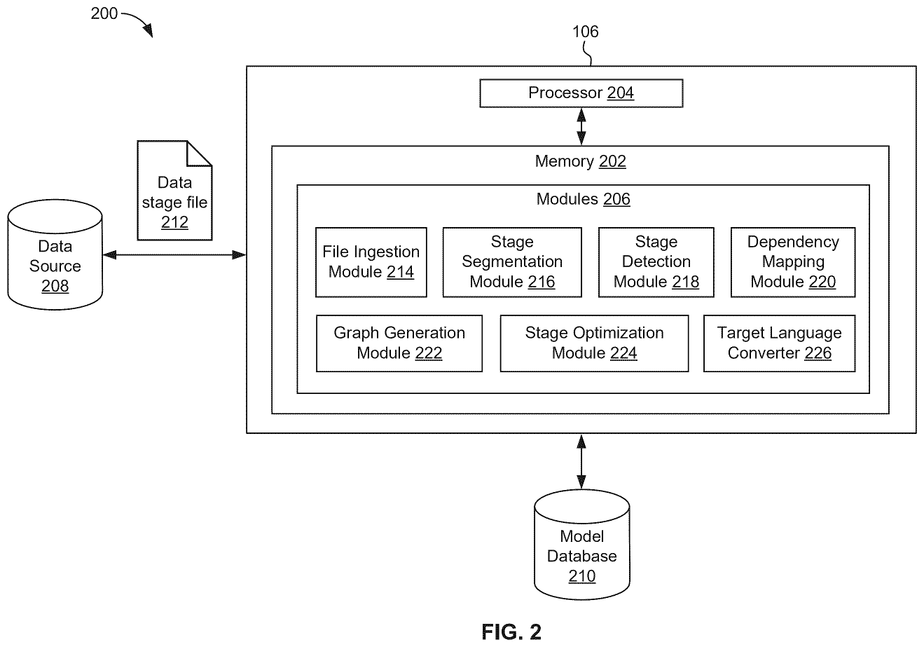

FIG. 2 illustrates an example architecture 200 of the back-end system 106 for GenAI-based conversion of the data stage file to the target language, in accordance with implementations of the present disclosure. The back-end system 106 may include one or more non-transitory processor-readable medium (herein referenced as memory) 202 storing instructions to be executed by the one or more hardware processors 204. In the back-end system 106, the one or more hardware processors 204 may be communicably coupled with the one or more memory 202 and configured to execute the machine-executable instructions. In some examples, the one or more hardware processors 204 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more hardware processors 204 may be programmed to cooperate with non-transitory processor-readable instructions stored in one or more memory 202 for performing operations according to the present disclosure. The one or more memory 202 may be non-transitory or non-volatile medium, such as a magnetic disk or solid-state non-volatile memory or volatile medium such as Random Access Memory (RAM), and/or the like.

In some examples, the one or more memory 202 may include modules 206 in the form of programmable instructions executable by the one or more hardware processors 204. The modules 206 may further include a file ingestion module 214, a stage segmentation module 216, stage detection module 218, a dependency mapping module 220, a graph generation module 222, stage optimization module 224 and a target language converter 226. The modules 206 may be communicatively coupled to a data source 208.

Further, the back-end system 106 may be communicatively coupled to a model database 210. The model database 210 may include one or more LLMs (also be referenced to as GenAI models, foundation models, natural language processing (NLP) model and/or the like). In an implementation, the LLMs may include pre-trained LLMs or generated LLMs. The pre-trained LLMs may be general-purpose GAI models like large deep learning neural networks, which may be trained using a broad range of generalized and unlabelled training data to perform one or more tasks, such as, human computer interactions (i.e., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

In an aspect, the file ingestion module 214, in the modules 206, may receive data stage file(s) 212 from the data source 208. The data source may serve as a repository all data stage files 212, for example, Binary Large Object (BLOB), Git, or the like. The file ingestion module 214 may establish a connection to the data source 208 by utilizing specific protocols and credentials depending on the data source 208 type. For example, the file ingestion module 214 may utilize operating system-level file input/output (I/O) operations (e.g., open( ) read( ) listdir( ) in Python) to access local or network file systems (e.g., network file system (NFS), server message block (SMB)). Further, the file ingestion module 214 may interact with version control systems (e.g., global information tracker (Git), subversion (SVN)) via the command-line interfaces or application programming interfaces (APIs) to identify or access specific revisions of data stage file 212 directories. Additionally, the file ingestion module 214 may implement software development kits (SDKs) or libraries specific to cloud storage services (e.g., AWS S3, Azure Blob Storage, Google Cloud Storage) to authenticate and access relevant buckets and objects in the data stage file 212. In an aspect, the file ingestion module 214 may provide necessary credentials (e.g., usernames, passwords, API keys, access tokens) to authenticate with the data source 208 and ensure authorized access to the required data stage files 212. The file ingestion module 214 may, further, utilize configuration parameters or input to determine the specific file paths or directory structures containing the data stage files 212. For instance, file paths or directory structures may include regular expressions or pattern matching to identify data stage files 212 based on naming conventions or extensions (e.g., .dsx for exported data stage files 212). The file ingestion module 214 may recursively navigate directory structures within the specified path (in the data source 208) to identify all relevant data stage files 212. Once identified, each data stage file may be opened, and the contents may be read into memory as a stream of bytes or text. The encoding of the data stage file 212 (e.g., Unicode Transformation Format-8-bit (UTF-8), American Standard Code for Information Interchange (ASCII)) may be analyzed during the reading process.

Moreover, the data stage file 212 may be related to a process. In other words, the data stage file 212 may include the definition of a specific data integration process. The process may be a logical sequence of operations designed to achieve a particular data-related objective, such as data warehousing, data migration, or data quality improvement. The data stage file 212 may serve as a blueprint or specification for said process. Herein, the process may include a plurality of stages of multiple stage types. The plurality of stages may indicate that the process may include multiple interconnected processing units. Furthermore, the plurality of stages may include multiple stage types. Each stage type (of the multiple stage types) may represent a distinct category of data processing functionality provided by data stage (e.g., data extraction, data transformation, data loading, data quality checks, data joining, data aggregation, or the like). Furthermore, a stage of the plurality of stages may represent a specific operation in an extract, transform, load (ETL) process. For instance, the extract stage may include multiple stage types, such as open database connectivity (ODBC) connector, sequential file and/or extensible markup language (XML) input, which are responsible for extracting data from various source systems in the data source 208. Further, the transform stage may include multiple stage types, such as transformer, filter, sort and/or lookup, which may perform data manipulation, cleansing, enrichment, and conversion. The load stage may include multiple stage types, such as delta load, change data capture (CDC) load and/or data enterprise, which may be used to load the processed data into target systems.

In further detail, the data stage file 212 may be a script file. Herein, the script file may refer to a file format used for exporting and importing data stage job definitions and metadata. The data stage file 212 may be an XML-based file including the structure and design of data stage jobs, including the stages, links, and corresponding configurations, along with other associated metadata. Further, the script file may include information regarding the process including user interface (UI) components, metadata, the plurality of stages, logic corresponding to the plurality of stages. The information regarding the UI components may include definitions related to visual representation of the data stage file 212 within the data stage designer UI. The information may further include information about a layout of the stages, graphical properties (e.g., position, color), and annotations. The information regarding the UI components may facilitate determining an intended design and workflow. Moreover, the information regarding the metadata may include, but not limited to, data stage file 212 properties, stage properties, data definitions (schema) and connection details. The non-limiting examples of the data stage file 212 properties may include name, description, version, creation date and last modified date. The non-limiting examples of the stage properties may include name, descriptions and types of individual stages. The data definitions (schema) may include structure and data types of data flowing through the input links and the output links (e.g., column names, data types, lengths, precisions, or the like). The connection details may include information required to connect to data source 208 and targets (e.g., database names, server addresses, file paths, or the like). The information regarding the plurality of stages may define the set of individual processing units (or stages) which constitute the data stage job. Herein, the data stage job may refer to a collection of linked stages and transformations defining how to extract, transform, and load data from source systems to target systems. Each stage definition may include stage type (e.g., transformer, join, lookup) and an unique identifier within the data stage job.

Furthermore, the information regarding the logic corresponding to the plurality of stages may include, but not limited to, transformation rules, filtering conditions, join conditions, aggregation definitions and data source 208/target specific logic. Specifically, the transformation rules may refer to expressions, functions, and techniques defined within transformer stages to manipulate data. The filtering conditions may refer to Boolean expressions used in filter stages to select specific data records. The join conditions may refer to specifications defining how records from multiple input links are combined in join and lookup stages. The aggregation definitions may refer to specifications for grouping data and applying aggregate functions (e.g., summation (SUM), average (AVG), counting (COUNT), or the like) in the aggregator stages. The data source 208 or target specific logic may refer to configuration details for interaction of stages with external systems (e.g., structured query language (SQL) queries for database stages, file format specifications for file stages). The information regarding the input links may define the incoming data streams for a particular stage, specifying the source stage and the data schema being received. Additionally, the information regarding the output links connecting the plurality of stages may define the outgoing data streams from a stage, specifying the destination stage(s) and the data schema being transmitted. The script file may include information about which output links of one stage are connected to the input links of subsequent stages, thus defining the execution order and data pipeline.

Further, the file ingestion module 214 may parse or break down the raw text of the data stage file 212 into a sequence of meaningful units called tokens. After that, a lexer or scanner may read the data stage file 212 character by character and identify patterns corresponding to tokens. The patterns may be identified using regular expressions. The non-limiting examples of tokens may include keywords (e.g., stage, type, property, link, input, output), identifiers (e.g., stage names, link names, property names), operators (e.g., =, :, (, ), , ), literals (e.g., string values, numeric values), delimiters (e.g., semicolons, commas, curly braces) and whitespace. Thereafter, the file ingestion module 214 may analyze the sequence of tokens to determine grammatical structure of the text according to a pre-defined grammar. The analysis may include verifying if the tokens are arranged in valid order and form meaningful constructs. Specifically, a parser (in the file ingestion module 214) (not shown in FIG. 2) may receive the stream of tokens as input and build a hierarchical representation of the script's structure, for instance, in the form of an abstract syntax tree (AST) or a similar data structure. The grammar, may be defined using formal notations such as backus-naur form (BNF) or extended backus-naur form (EBNF), may specify the rules defining the combination of tokens. The parser may utilize parsing techniques such as top-down parsing (e.g., recursive descent) and/or bottom-up parsing (e.g., left-to-right, rightmost derivation in reverse (LR) parsing). The top-down parsing may start with the root of the grammar and aim to match the input tokens. The bottom-up parsing may start with the input tokens and aim to build up the parse tree. The parser may produce a structured representation (like the AST) which reflects the relationships between different elements of the data stage job definition in the data stage file 212. For example, the structured representation may represent that the stage has certain properties and links. Within the structured representation, the file ingestion module 214 may identify stage names of the plurality of stages or attributes representing the stage names. Using the identified stage names, the file ingestion module 214 may further parses the data stage file 212 to extract the complete definition for each stage.

Furthermore, the structured representation may undergo semantic analysis by the file ingestion module 214, thereby ensuring that the data stage file 212 is syntactically correct and semantically valid according to the rules of the data stage job definition in the data stage file 212. The file ingestion module 214 may traverse the structured representation and perform verifications. The verification may include ensuring that the data is used correctly in expressions and assignments. The verification may further include verifying all identifiers (stage names, link names) are declared and used consistently. Additionally, the verification may include enforcing specific rules related to data stage file 212 definitions (e.g., ensuring all stages have a type, links connect valid input and output ports). Once the data stage file 212 is parsed and semantically analyzed, the file ingestion module 214 may receive the data stage file 212 including the information regarding UI components, metadata, the plurality of stages, logic corresponding to the plurality of stages and the input links and the output links connecting the plurality of stages. The received information may be stored in structured data formats within the file ingestion module 214, such as, dictionaries/maps, lists/arrays, graph data structures and custom objects/classes.

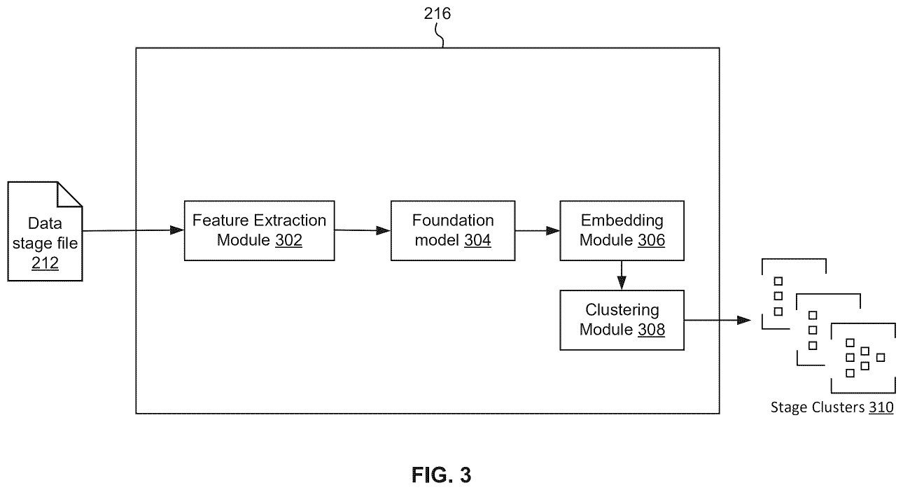

Further, the stage segmentation module 216 may receive the data stage file 212 from the file ingestion module 214 for further processing. The stage segmentation module 216 may generate stage clusters corresponding to the plurality of stages, by using a plurality of entities (also referenced as entities) output by a foundation model (represented as foundation model 304 in FIG. 3). The stage clusters may be generated by aggregating two or more entities of the plurality of entities based on similarity. Herein the entities may be the output by the foundation model in response to receiving the data stage file 212 as input. Specifically, the stage segmentation module 216 on receiving the data stage file 212, may extract features including structural features and semantic features from the data stage file 212, followed by inputting the structural features and the semantic features to the foundation model. The foundation model may be trained to identify and label specific parts of the data stage job definition in the data stage file 212, thereby identifying the functionality and structure. The entities may determine the low-level syntax of the script and provide a higher-level analysis of the data stage files 212. For example, the entities within the data stage file 212 may include stages, jobs, parameters, datasets, and containers. The stages may refer to operations like data extraction, transformation, and loading (ETL). The jobs may refer to collection of stages defining the complete ETL process, from extracting data to loading it into a target system. The parameters may refer to variables used within a job to make said job more flexible and reusable. The datasets may refer to operating system files, each referred to by a control file, which by convention has the suffix .ds. Moreover, the data stage file 212 may include types of containers such as local containers (created within a job) and shared containers (created separately and stored in the data source 208). In essence, the stage segmentation module 216 may utilize the entities to determine the structure and relationships within the data stage file 212 at a semantic level. The stage segmentation module 216 is described in further detail in conjunction with FIG. 3.

Furthermore, the stage detection module 218 may aggregate one or more subsets of the plurality of stages in the received data stage file 212, from the stage clusters, corresponding to a transformation stage type of the multiple stage types. The stage detection module 218 may analyze the plurality of stages in the data stage file 212 and may group together or aggregate said one or more subsets of the plurality of stages, based on pre-defined criteria. Specifically, in the data stage file 212, each stage of the plurality of stages may perform a different function (for example, source data extraction, target data loading, data quality checks, or the like). The stage detection module 218 may aggregate one or more subset based on pre-defined criteria defined corresponding to the transformation stage type. The stage segmentation module 216 may iterate through the plurality of stages and apply filter to identify the stage type attribute matching the pre-defined criteria including the predefined set of transformation stage types (e.g., “transformer,” “modify,” “pivot”). Herein, the transformation stage may refer to the type of stage used for performing data transformations within the ETL job. The transformation stage may facilitate filtering, deriving new values, and/or redirecting data based on defined rules. In other words, the transformer stage may perform various data manipulation needs.

Moreover, the stage detection module 218 may classify, by a transformer-based classification model, the plurality of stages into the multiple stage types and identify the transformation stage type of the multiple stage types. The transformer-based classification model may refer to deep learning model based on the transformer network (for example, Bidirectional Encoder Representations from Transformers (BERT), Robustly Optimized BERT Pretraining Approach (ROBERTa), DistilBERT). The transformer-based classification model determines the context and relationships within sequential data included in the input. Herein, the input to the transformer-based classification model may be textual representations of the stage definitions (e.g., extracted properties, configuration details, code snippets associated with the plurality of stages). The input may be broken down into tokens (words or sub-words) and converted into numerical representations (embeddings) which the transformer-based classification model may interpret. The transformer-based classification model may process the sequence of embeddings and output a probability distribution over the different stage types. The stage type with the highest probability may be assigned as the predicted type for corresponding stage. The transformer-based classification model may classify each stage in the data stage file 212 into one of the multiple stage types (for example, Source, Target, Transformer, Join, Aggregator, Filter, or the like). As a result of the classification, the stage detection module 218 may specifically identify which of the plurality of stages belong to the transformation stage type.

In an instance, the stage detection module 218 may utilize named entity recognition (NER) model as the transformer-based classification model. The NER model may process the said input to identify and extract specific entities from the stage definitions in the data stage file 212. The non-limiting example of the specific entities may include a flag run name and an operator type. The flag run name may refer to identifiers related to the execution or logging of the job defined in the data stage file 212. The operator type may refer to specific operation being performed within the stage (for example, lookup join, sort, aggregate, or the like). The processing by the NER model may include tokenization, followed by encoding said input. After that, the NER model may assign a tag to each token, indicating whether the token belongs to the specific entity type (e.g., “B-FLAG_RUN_NAME” for the beginning of a flag run name, “I-FLAG_RUN_NAME” for subsequent tokens of the same name, “B-OPERATOR_TYPE” for the beginning of an operator type). The tagged tokens may be then grouped together to form the identified entities along with the types.

Furthermore, the data representing a transformation logic from all identified transformation stage type may be processed by a semantic embedding model (not shown in FIG. 2), in the stage detection module 218. The semantic embedding model may identify specific instructions or expressions defining the transformations within each transformation stage type. The identified specific instructions or expressions may be encoded by a pre-trained or custom-trained semantic embedding model (e.g., Sentence-BERT, Universal Sentence Encoder). If there are multiple transformation stage types, corresponding individual logic embeddings may be combined (e.g., by averaging) to produce a single, high-level representation of an overall transformation intent of the job defined in the data stage file 212.

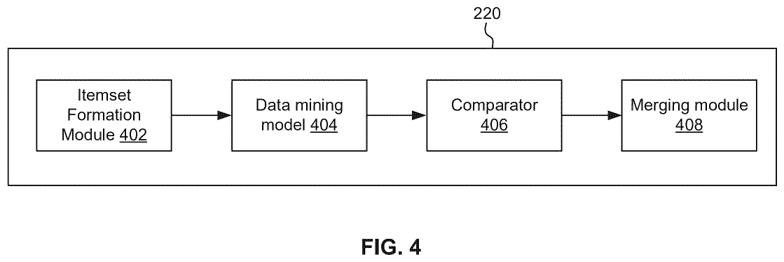

Further, the dependency mapping module 220 may generate, by using a data mining model 404, logical flow including input links and output links between the subset of the plurality of stages. Herein the data mining model 404 may provide the output in response to receiving the one or more subsets of the plurality of stages as input. The dependency mapping module 220 220 may determine the movement of the data between different stages within the data stage file 212. The dependency mapping module 220 may create a logical diagram or data structure explicitly showing the connections and flow of data. The representation of the data movement may be called as the logical flow. The input links may include the data streams entering the stage from a preceding stage and the output links may include the data streams leaving a stage and going to a subsequent stage. Moreover, the data mining model 404 may analyze the stages to infer or predict the logical flow. The data mining model 404 may refer to the ML model (supervised and/or unsupervised) trained to discover patterns, relationships, or insights from data. Herein, the data may include the characteristics and the connections of the one or more subset of the plurality of stages. The dependency mapping module 220 is described in further detail in conjunction with FIG. 4.

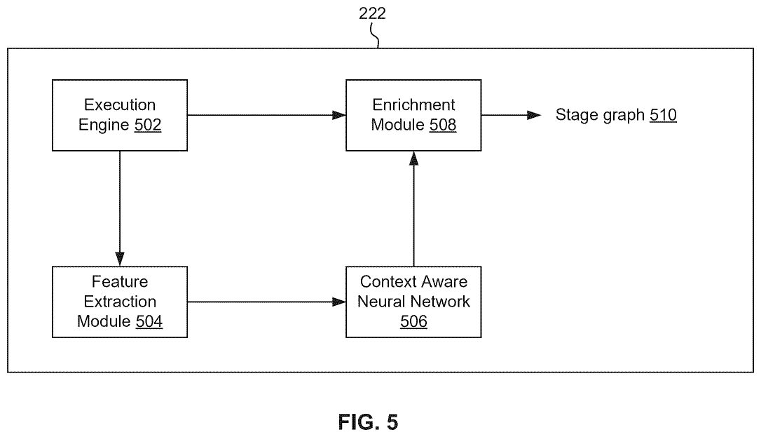

Furthermore, the graph generation module 222 may generate a stage graph representing the logical flow. Herein the nodes of the stage graph may represent corresponding stages of the plurality of stages and edges of the stage graph connecting the nodes may represent the input links and output links. The stage graph may visually represent the data flow within the data stage file 212. The stage graph may connect different stages, representing the data sources, processing steps, or target systems, to define data movement and transformation. In further detail, each stage in the stage graph may represent the specific operation on the data, such as reading from a file, transforming data, or loading data into the database. In essence, the stage graph may visually outline how the data is extracted, transformed, and loaded (ETL), showing the sequence of operations performed on the data in the data stage file 212. The graph generation module 222 is described in further detail in conjunction with FIG. 5.

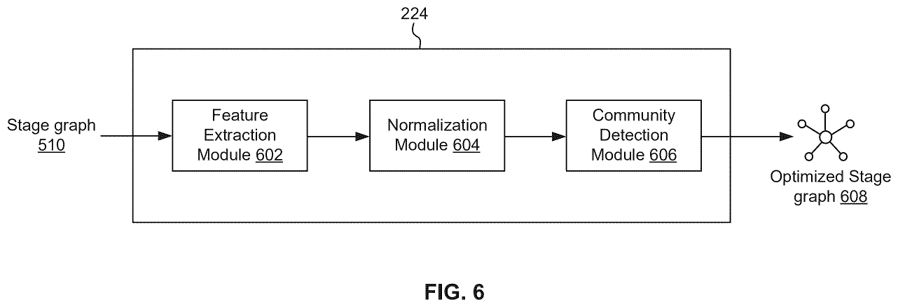

The stage graph generated by the graph generation module 222 may be received by the stage optimization module 224. The stage optimization module 224 may optimize the stage graph by clustering the nodes based on predetermined factors. Specifically, the stage optimization module 224 may apply clustering techniques to the nodes (stages) of the graph. Clustering techniques may refer to the unsupervised machine learning technique which groups data points (herein, nodes (stages)) based on the similarity according to the predetermined factors. The predetermined factors may include a stage type, a functionality, data characteristics, connectivity patterns, resource consumption, execution time and/or error rates or failure patterns. For instance, clustering the nodes based on the stage type may include clustering stages of the same type (for example, multiple transformer stages, multiple join stages), for bulk optimization or standardization. The clustering of the nodes based on the functionality may include grouping stages performing similar operations (for example, data cleansing, data aggregation, or the like) as inferred from the features or classified variables. The clustering of the nodes based on the data characteristics may include clustering of stages processing data with similar schemas, data volumes, or data sensitivity levels for tailored optimization strategies. The clustering of the nodes based on the connectivity patterns may include clustering of stages which are closely coupled or frequently appear together in sub-flows, to analyze the combined performance. The clustering of the nodes based on the resource consumption may include clustering of the stages with similar resource usage profiles (for example, high CPU, high memory), for resource management optimization. The clustering of the nodes based on the execution time may include clustering of the stages with similar execution durations, for scheduling or parallelization considerations. The clustering of the nodes based on the error rates or failure patterns may include clustering of the stages exhibiting similar error characteristics, for targeted debugging or resilience improvements. The stage optimization module 224 is described in further detail in conjunction with FIG. 6.

Further, the optimized stage graph, generated by the stage optimization module 224, may be received by the target language converter 226. The target language converter 226 may generate instructions converted to a target language (for example, SparkSQL) by providing the optimized stage graph as a prompt to a Large Language Model (LLM). Specifically, the target language converter 226 may serialize the optimized stage graph into the textual format that the LLM may interpret. The serialization may include representing nodes and their attributes as text. The serialization may further include representing edges and corresponding properties (for example, data flow direction, data schema) as text. Additionally, said serialization may include using the structured format like JavaScript Object Notation (JSON) or Yet Another Markup Language (YAML) to encode the optimized stage graph information. Moreover, the target language converter 226 may encode the connections between stages (input and output links, dependencies) by listing parent-child relationships or explicitly defining source and target nodes for each edge. Thereafter, the target language converter 226 may generate prompt, based on the serialized optimized stage graph. The prompt may include instructions specifying the target language and the desired format of the output. For example, the prompt may include “Translate the following DataStage job definition into [Target Language] code. Represent each stage as a corresponding construct in [Target Language], maintaining the data flow and transformations. Output the code in a well-structured and readable format”. Additionally, the prompt may include context about data stage file 212 concepts and the equivalents in the target language, thereby enabling the LLM to determine the semantics. For example, the prompt may include “In DataStage, a ‘Transformer’ stage is used for data manipulation. In [Target Language], this can be implemented using [relevant language constructs or libraries]”.

Furthermore, the target language converter 226 may transmit the generated prompt to API endpoint of the LLM (for example, OpenAI API for GPT models, Google Cloud AI Platform for PaLM models), in the model database 210. API parameters, corresponding to the API endpoints, such as the LLM to use, temperature (controlling randomness), maximum output tokens, and other generation settings may be configured by the target language converter 226. The LLM in response to receiving said prompt may generated text (the translated instructions into the target language) as a response. Moreover, the LLM may be fine-tuned on domain-specific dataset for accurate conversion. Specifically, to fine tune the LLM, dataset of paired examples may be created. Each example may include input, said input may represent the data stage graph. The input may be in the serialized format (JSON, YAML, custom text) used as the prompt for the LLM. The example may further include output, said output may represent the corresponding translation of that data stage graph into the target language (for example, Python code using a specific data processing library, SQL queries, or the like). The dataset may include a wide range of data stage constructs, transformations, stage types, and the equivalents in the target language. Additionally, the dataset may further include examples of common data flow patterns and complex scenarios specific to the data stage file 212 domain.

Further, the created dataset may undergo cleaning and preprocessing to ensure consistency in formatting and representation. The cleaning and preprocessing may include standardizing the serialization of the data stage graphs and the syntax of the target language examples. After that, a suitable pre-trained LLM may be selected as the base model for fine-tuning. The selection may depend on factors like the complexity of the task, the desired output quality, computational resources, and accessibility. The non-limiting examples of the base model may include OpenAI (GPT series), Google (PaLM, Gemini), and open-source models (e.g., Llama, Mistral).

Further, the back-end system 106 may fine-tune the selected LLM by utilizing libraries and frameworks (e.g., TensorFlow, PyTorch, Hugging Face Transformers library). The back-end system 106 may set the hyperparameters for the fine-tuning process. The hyperparameters may include but not limited to, a learning rate, a batch size, number of epochs, an optimizer, loss function and regularization techniques. Herein, setting the learning rate may refer to controlling the step size during weight updates. The batch size may refer to the number of examples processed in each training step. The number of epochs may refer to the number of times the entire dataset is passed through the LLM. The optimizer may refer to technique used to update the LLM's weights (e.g., Adam, Adafactor). The loss function may refer to function measuring the difference between the LLM's predictions and the actual outputs in the training data (for example, cross-entropy loss for sequence generation). The regularization techniques may refer to the techniques to prevent overfitting (for example, dropout, weight decay).

In further detail, the prepared dataset may be input to the LLM using the configured training setup. The LLM may iteratively adjust the weights based on the difference between its generated translations and the ground truth translations in the dataset, as determined by the loss function. The back-end system 106 may monitor the training process using metrics like loss and evaluation metrics (for example, bilingual evaluation understudy (BLEU) score, Recall-Oriented Understudy for Gisting Evaluation (ROUGE) score, or the like). After fine-tuning, the back-end system 106 may evaluate the performance of the LLM on a validation dataset (different from the dataset used during training), thereby determining the performance of the LLM on new, unseen data stage graphs. Once a satisfactory level of performance is achieved, the fine-tuned LLM may be deployed for use by the target language converter 226. The target language converter 226 may then use said fine-tuned model to generate instructions converted to the target language translations when provided with the optimized data stage graph as the prompt.

FIG. 3 illustrates a block diagram representation of the stage segmentation module 216 for generating stage clusters 310 corresponding to the plurality of stages in the data stage file 212, in accordance with implementations of the present disclosure. The stage segmentation module 216 may further include a feature extraction module 302, a foundation model 304, an embedding module 306 and a clustering module 308. On receiving the data stage file 212 from the file ingestion module 214, the feature extraction module 302 in the stage segmentation module 216, may extract features including structural features and semantic features from the extracted data stage file 212. The structural features may refer to the physical organization and layout of the data, including data types, column names, and table structures. For example, the structural features may include data types (types of data stored in each column (e.g., integer, string, date)), stage types (the specific type of each stage used in the data stage file 212 (e.g., transformer, join, lookup, sequential file, ODBC connector), number of stages (the total count of processing units), number of links (the total count of data flow connections between stages), stage connectivity (or topology) (how stages are connected to each other (e.g., fan-in, fan-out, linear flow, parallel branches)), link direction (whether a link is an input or output link for a particular stage), number of input/output links per stage (the degree of connectivity for each stage), file formats (the format of the input and output files (e.g., comma-separated values (CSV), extensible markup language (XML), JSON, data structures (the way data is organized within the data stage file 212 (e.g., relational, hierarchical, or key-value)) and data definitions (the formal descriptions of the data, including data types, lengths, and constraints). Moreover, the semantic features may refer to the meaning and context of the data. In other words, the semantic features may describe the meaning and operations performed within the data stage file 212. The semantic features may define functions performed by the data stage file on the data, including the transformations, logic, and data flow intent. For example, the semantic features may include, organizational rules (rules governing the way data may be transformed or validated), data definitions (the meaning and context of the data, such as what a particular column represents), data lineage (tracking the origin and transformations of data), specific transformation functions (e.g., trim( ) substring( ) lookup( ) aggregate functions), join conditions and types (the keys and types of joins (e.g., inner, outer, left) used in join and lookup stages), data governance policies (the policies governing how data is accessed, used, and protected), dimension tables (tables storing descriptive attributes about entities, used to contextualize facts and fact tables (tables storing the core data or metrics, often joined with dimension tables.

Further, the feature extraction module 302, after receiving the data stage file 212, may iterate through the different components of the data stage file 212 (e.g., stages, links, properties) and identify the structural features. The identification of the structural features may include, but not limited to rule-based identification, hierarchy analysis, type recognition and extraction of name and identifiers. The rule-based identification may include utilization of predefined rules to identify structural keywords (e.g., STAGE, INLINK, OUTLINK, delimiters like parentheses and semicolons). The hierarchy analysis may include analyzing the hierarchical relationships between different elements (e.g., a STAGE block containing INLINK and OUTLINK definitions). The type recognition may include identifying the types of stages (e.g., input stage, transformation stage) and link types. The extraction of names and identifiers may include extracting the name given to stages and links (e.g., input stage, out to transform). The identified structural features may be then stored in a structured format, such as dictionaries or objects, where the type of structural-feature and the associated information are explicitly labeled.

In an example, the identified structural feature from the data stage file 212, may be expressed as below:

STAGE InputStage (
INLINK: OrderID, CustomerID;
);

The above structural feature may represent a stage named “InputStage”. “STAGE InputStage” may indicates the beginning of the definition for the stage named “InputStage.” The keyword STAGE and the stage name are structural features. Furthermore, “INLINK: OrderID, CustomerID” may defines an input link to the “InputStage.” The keyword INLINK and the name of the fields (OrderID, CustomerID) arriving on this link may be the structural features, indicating the input interface of this stage. The semicolon “;” may mark the end of the link definition. Additionally, the parentheses may define the beginning and end of the ‘InputStage’ block, clearly establishing the scope and nesting within the overall job.” Herein, the structural elements like parentheses may define the boundaries and hierarchical organization of the data stage file 212 components.

Furthermore, the feature extraction module 302 may identify the semantic features from the received data stage file 212. Specifically, the feature extraction module 302 may identify keywords indicating semantic operations (e.g., transformation, filter, join condition, aggregate). The feature extraction module 302 may utilize regular expressions or pattern matching techniques to identify common semantic structures (e.g., IF, THEN, ELSE, or the like). Further, the feature extraction module 302 may identify specific sections of the data stage job definition in the data stage file 212 (e.g., the content within a transformation stage). The feature extraction module 302 may analyze the identified specific sections by utilizing techniques such as natural language processing. Specifically, the feature extraction module 302 may access the GenAI models stored in the model database 210. The GenAI model may analyze the identified specific sections and in response, output structured representations of the semantic meaning. The feature extraction module 302 may then associate the extracted semantic features with the corresponding structural features (e.g., linking the “transformation rule” to the “transformation stage”).

In an example, the identified semantic feature from the received data stage file 212 may be expressed as below:

STAGE TransformationStage (
TRANSFORMATION: IF (OrderStatus = ‘New’) THEN
ProcessOrder ELSE ‘NotifyCustomer’;
);

The above semantic feature may represent a stage named “TransformationStage”. Herein, “STAGE TransformationStage” may indicate the beginning of the stage named “TransformationStage”. Further, “TRANSFORMATION: IF (OrderStatus=‘New’) THEN ProcessOrder ELSE ‘NotifyCustomer’;” may defines the data transformation rule within the “TransformationStage”. Specifically, the keyword “TRANSFORMATION” indicates the presence of a semantic operation. Moreover, “IF (OrderStatus=‘New’) THEN ProcessOrder ELSE ‘NotifyCustomer” may indicate the actual transformation logic, expressing a condition “(OrderStatus=‘New’)” and the corresponding actions “(ProcessOrder or ‘NotifyCustomer’)”. The entire expression, including the condition and the outcomes, may be a semantic feature describing the data manipulation being performed. In essence, the keyword “transformation” may define the operation of stage and the transformation of the data. The keywords like “TRANSFORMATION” and the subsequent conditional logic may capture the semantic meaning of the stage's operation.

Furthermore, the feature extraction module 302 may input the structural features and the semantic features to the foundation model 304. Herein, the foundation model 304 may be a deep learning model stored in the model database 210. The foundation model 304 may be trained for domain-based named entity recognition. The foundation model 304 may be trained with data including the structural features and the semantic features. For instance, the foundation model 304 may be model is trained using techniques such as self-supervised learning. The self-supervised learning technique may refer to the type of machine learning technique where the foundation model 304 may learn representations from unlabeled data by creating the own supervisory signals. Further, the foundation model 304 may output the plurality of entities in response to the input the structural features and the semantic features. The deep learning model may refer to the AI model with multiple layers (e.g., convolutional neural networks (CNNs), recurrent neural networks (RNNs), transformers) capable of learning complex representations and patterns from the input structural features and the semantic features. The foundation model 304 may be trained to implement techniques such as named entity recognition (NER), within the context of data stage job definitions defined in the data stage file 212. The NER may refer to a subtask of information extraction to locate and classify named entities mentioned in unstructured text into pre-defined categories. Herein, the unstructured text may refer to the sequence of structural and semantic features, and the pre-defined categories may refer to the entities relevant to understanding data stage file 212 (e.g., stage names, transformation functions, data fields, connection parameters). The foundation model 304 may be trained to identify the entities based on the patterns and relationships within the input structural and semantic features.

In an instance, the foundation model 304 may be a long short-term memory (LSTM) networks with conditional random fields (CRF). In the LSTM-CRF model, the LSTM network may be a type of RNN model which may process the input structural features the semantic features by identifying the dependencies and contextual information between different parts of input. After that, the LSTM network may generate a set of features for each position in the sequence. For example, the LSTM network may identify that a “transformation” keyword is often followed by expressions or that INLINK is associated with column names. The generated set of features may be then fed into the CRF layer, which may model the dependencies between labels and predict the most likely sequence of labels. Specifically, the CRF may model the dependencies between the labels assigned to consecutive features. For example, the CRF may determine that an entity label such as INPUT_FIELD may be followed by another INPUT_FIELD or a punctuation mark. In further detail, structural features the semantic features may be segmented into the sequence of tokens prior to the input into the LSTM-CRF model (foundation model 304). For each token in the sequence, a feature vector may be created. The feature vector may encode both structural and semantic information associated with said token. On receiving the structural features the semantic features, the LSTM may process the input sequentially, maintaining a hidden state which may capture information about the preceding tokens. Thus, the LSTM may identify dependencies and understand the context of each token within the data stage file. For example, the LSTM can identify that tokens appearing within a TRANSFORMATION block have a different semantic role than tokens within an INLINK definition. The output of the LSTM may be the sequence of hidden states, where each hidden state may represent the contextualized information for the corresponding token. The sequence of hidden states from the LSTM may be then passed to the CRF. The CRF may models the dependencies between the labels assigned to each token. Moreover, the LSTM-CRF model, by utilizing techniques such as NER may determine labels representing the different types of entities (e.g., stage name, input link name, output link name, column name, transformation function, condition operator, literal value, or the like). The CRF may identify transition probabilities between the labels. For instance, the CRF may identify that after a stage keyword token is labeled, the next token may be labeled as stage name. Therefore, the CRF may utilize the LSTM's output and the identified transition probabilities to predict the sequence of entity labels for the input token sequence, ensuring label consistency and structural validity in the output.

In an example, the foundation model 304 (for example the LSTM-CRF) may output the entities, expressed as below, on receiving the data stage file 212 as input:
STAGE: “Copy of DS SERV REPO”
Inputs: “‘Copy_307:In_GENERIC_DS_Part.v’”
Outputs: “‘Jn Valid_Service:In FN QUERY ECL.v’”
   Herein, the foundation model 304 has recognized “Copy of DS SERV REPO” as the name of the stage. Further, the foundation model 304 has identified the input specification, potentially including a link name and/or a dataset identifier (that is “‘Copy_307:In_GENERIC_DS_Part.v’”). Similarly, the foundation model 304 has identified the output specification (that is, “‘Jn Valid_Service:In FN QUERY ECL.v’”).

Furthermore, an embedding module 306 may receive the output entities from the foundation model 304. The embedding module 306 may obtain embeddings by transforming the entities output by the foundation model 304 in response to inputting the structural features and semantic features. In other words, the embedding module 306 may convert the discrete and symbolic representations of the identified entities from the data stage file 212 into continuous, vector-based representations called embeddings. For instance, for entities which belong to a finite set of categories (e.g., stage types like “Transformer,” “Join,” “Lookup”), the embedding module 306 may utilize a pre-trained or custom-trained embedding matrix. The embedding matrix may assign a unique vector to each distinct category. The entity (e.g., the string “Transformer”) may be used as an index to look up its corresponding vector in the embedding matrix. Moreover, for entities which are text strings (e.g., stage names like “customer data processing,” column names like “order_id,” transformation expressions), the embedding module 306 may implement techniques such as NLP to generate text embeddings. Specifically, the entity string may be broken down into individual words or sub-word units. Each token may be then converted into the vector using a pre-trained model (e.g., Word2Vec, global vectors (GloVe), FastText) or a model trained specifically on data stage file 212 related text. The embeddings of the individual tokens may be then combined (e.g., by averaging or using more sophisticated pooling mechanisms) to produce the single embedding vector for the entire entity string. In an aspect, the embedding module 306 may combine multiple techniques. For example, the stage type could be represented by a lookup embedding, while the stage name is represented by a textual embedding. The individual embeddings may be then concatenated or combined to obtain the final embedding for the stage entity.

Further, the obtained embeddings from the embedding module 306 may be transmitted to the clustering module 308. The clustering module 308 may cluster said embeddings into the stage clusters 310, by using machine learning model (from the model database 210). Herein, stage clusters may be generated by aggregating two or more entities of the plurality of entities based on similarity. In other words, the stage clusters 310 may include the groups of data stage file 212 entities which have been identified as similar to each other based on the obtained embeddings. The stage clusters 310 may include stages with similar functionality, for example, the stage cluster may contain embeddings of multiple transformer stages performing similar types of data manipulation (e.g., string cleaning, data type conversions). Moreover, the stage cluster may include embeddings of stages which are sequentially linked and operate on related data may be clustered together. Further, the stage clusters 310 may include functional groups of entities within the stage. For instance, within the “transformer” stage, the embeddings of the input links, output links, and the transformation logic may form the stage cluster representing the internal workings of said transformer stage. Specifically, the clustering module 308 may measure the similarity or distance between two embedding vectors, by utilizing techniques such as euclidean distance and/or cosine similarity. The clustering module 308 may further utilize clustering techniques to the set of embedding vectors using the chosen metric. For example, the clustering technique may include K-means, hierarchical clustering, density-based spatial clustering of applications with noise (DBSCAN) and/or agglomerative clustering. The K-means clustering technique may partitions the data into k clusters by iteratively assigning data points to the nearest cluster centroid and updating the centroids. The K-means clustering technique may estimate an appropriate value for k (specifying the number of clusters (k)) by implementing elbow method or silhouette analysis. The hierarchical clustering may create a hierarchy of clusters, either by starting with each data point in its own cluster and iteratively merging the closest clusters (agglomerative) or by starting with one cluster containing all data points and recursively splitting clusters (divisive). The DBSCAN may group together data points which are closely packed together, marking as outliers points lying in low-density regions. The agglomerative clustering may refer to the type of hierarchical clustering where each data point starts as its own cluster, and pairs of clusters are merged as one moves up the hierarchy. Once the clustering is performed, each embedding of the entity may be assigned to a specific cluster based on its similarity to the cluster's centroid (for centroid-based methods) or its proximity to other points in the cluster (for density-based methods). Subsequently, the clustering module 308 may output the resulting stage clusters 310, where each cluster may include a collection of the identifiers or original representations of the entities of which embeddings were grouped together.

FIG. 4 illustrates a block diagram representation of the dependency mapping module 220 for generating logical flow between the subset of the plurality of stages in the data stage file 212, in accordance with implementations of the present disclosure. On receiving the one or more subset of the plurality of stages as input, the itemset formation module 402 may convert the data in the one or more subset into itemset. The itemset may represent the key attributes (for example, stage names, operators, input/output links, fields, or the like) as individual items. In other words, each itemset may represent a single component of the stage in the data stage file 212 and may include a collection of the attributes (for example, stage name, operator type, input link name, input fields, output link name, output fields, or the like).

In an example, the stage and the corresponding one or more subset received by the itemset formation module 402, may be expressed as below:

Stage: Copy_of_ds_ECL_TRACKING
Subset:
#### STAGE: Copy_of_ds_ECL_TRACKING
## Operator
copy
## General options
[ident(‘Copy_of_ds_ECL_TRACKING’)]
## Inputs
0< [ ] ‘Remove_Duplicates_309:In_TRF_QUERY_ECLI.v’
## Outputs
0>| [ds] ‘[&\”BSL_P

Further, on receiving the above one or more subset, the itemset formation module 402 may convert the data in said example of one or more subset into itemset expressed as below:
Stage Copy_of_ds_ECL_TRACKING
s represented as {“entities”: [“‘Remove_Duplicates_309:In_TRF_QUERY_ECLI.v’”, “[ds] ‘[&\“BSL_P”]}.
   Herein, for the “Copy_of_ds_ECL_TRACKING” stage, the itemset may include the name, input link name, and input fields.

Moreover, the itemset generated from the itemset formation module 402 may be received by the data mining model 404. Herein, itemset from may be called as transaction, and the attributes within the itemset may be called the items in the transaction. For example, the itemset for “Copy_of_ds_ECL_TRACKING” could be treated as a transaction containing items like, expressed as below:
{“STAGE: Copy_of_ds_ECL_TRACKING”, “OPERATOR: copy”, “INPUT_LINK: Remove_Duplicates_306:In_TRE_QUERY_ECL.v”, “INPUT_FIELD: ds”, “INPUT_FIELD: S\$L_P”}

The data mining model 404 may apply data mining techniques, on the received itemset to obtain as the output, a plurality of metrics for different combinations of the one or more subset of the plurality of stages. Herein, the plurality of metrics may include confidence, support and lift metrics. In an instance, the data mining model 404 may apply data mining techniques, such as, custom-Apriori technique. The custom-Apriori technique may include a sequence of steps to be followed to identify the most frequent itemset in the given database. The custom-Apriori technique (data mining technique) may implement the join and the prune steps iteratively until the most frequent itemset is identified. Additionally, a minimum support threshold may be pre-defined. The custom-Apriori technique may be applied by using scripting language like Python or Java, within the one or more subset. Specifically, the data mining module by applying the custom-Apriori technique, may identify the itemset occurring with a frequency above pre-specified minimum support threshold. The data mining model 404 may, thereafter, derive association rules based on the identified most frequent itemset, specifying values of the confidence, support and lift metrics. The support metric may be defined as the ratio of the number of times the item occurs in the transactions to the total number of transactions. The value of support metric may determine the probability of the occurrence of each individual item (denoted by “x”) in the transactions. The support metric may be calculated by utilizing the below expression:

$$Support ( x ) = \frac{\vert \{ transactions containing x \} \vert}{Total number of transactions}$$

Moreover, the value of confidence metric may identify the probability of items or itemsets occurring in the itemsets together. For example, if there are two items in the transaction, the existence of one item is assumed to lead to the other. The first item or itemset is the antecedent, and the second is the consequent. The value of confidence metric, thus, may be defined as the ratio of the number of transactions having both the antecedent and the consequent, to the number of transactions only having the antecedent. The value of the confidence metric may be expressed as below:

$$Confidence ( X ⇒ Y ) = \frac{Support ( X ⋃ Y )}{Support X}$$

wherein,
X may denote the antecedent;
Y may denote the consequent; and
confidence (X⇒Y) may denote the value of the confidence metric which X leads to Y.

Furthermore, the data mining model 404 may determine the value of the lift metric (also referenced as lift value). For example, the lift value may measure how much more often X and Y occur together than expected if they were statistically independent. In other words, the lift value may quantify the strength of association between X and Y. The lift value may be calculated by the data mining model 404 utilizing the below expression:

$$Lift ( X ⇒ Y ) = \frac{Confidence ( X ⇒ Y )}{Support ( Y )}$$

wherein,
Lift (X⇒Y) may denote the lift value for item X leading to item Y;
Confidence (X⇒Y) may denote the confidence value of item X leading to item Y; and
Support (Y) may denote the support for item Y.

In further detail, the lift value greater than one may imply that X and Y are positively correlated (X and Y occur together more often than expected). Further, the lift value less than one may imply that X and Y are negatively correlated (X and Y occur together less often than expected). Moreover, the lift value equal to one may imply that X and Y are independent.

Furthermore, the data mining model 404 may score each of the combinations of the one or more subset of the plurality of stages, based on the plurality of metrics. In an aspect, the data mining model 404 may score each of the combinations of the one or more subset based on the value of each metric (of the plurality of metric) independently (for example, a support score, a confidence score, a lift score). In another aspect, the data mining model 404 may provide single score calculated by combining the values of plurality of metrics using a weighted average or other aggregation function. The combined value may be determined based on the relative importance of each metric for the specific task of logical flow mapping in data stage file 212.

Further, a comparator 406 may compare the scores corresponding to each combination of the subset of the plurality of stages with a predefined threshold. That is, for every association rule or frequent itemset (representing a combination of stages or the attributes) which the data mining model 404 has generated and scored (by using plurality of metric including support, lift, and confidence), the comparator 406 may compare the calculated score(s) with predefined threshold. The predefined threshold may be set by the user 114 and/or 116 through configuration. There may be separate predefined thresholds for different metrics (e.g., a minimum support threshold, a minimum confidence threshold, a minimum lift threshold) or a single threshold applied to the combined score. For example, minimum confidence threshold may include that a confidence score of 0.75 or higher is considered appropriate and indicate a reliable dependency between stages. the minimum support threshold may include that only combinations of stages which appear in at least 5% of the analyzed data stage jobs are considered frequent enough to be relevant. Similarly, minimum lift threshold may include that only associations with the lift score greater than 1.2 are considered to reflect the significant positive correlation.

After the calculation of relevant scores (support, confidence, lift, or a combined score) for each of the combinations of the subset of the plurality of stages, the comparator 406 may compare each score against the predefined threshold for corresponding specific metric (or the combined score threshold). The comparison may include verifying if the score is greater than or equal to the predefined threshold. The comparator 406 may utilize the comparison operator (e.g., >=, >, <=, <) depending on the nature of the metric and predefined threshold. For example, for support and confidence metric, a value above a certain threshold may be valid. For lift, a value significantly greater than 1 may be considered valid. Based on the comparison with the predefined threshold(s), the combination of the subset of the plurality of stages may be either retained or filtered out. The combination of the subset of which the score(s) meet or exceed the predefined threshold(s), may be retained and passed on for further processing. Additionally, the combination of the subset of which the score(s) falls below the predefined threshold(s), may be filtered out.

Further, the merging module 408 may identify the input links and the output links for the subset of the plurality of stages based on the comparison of the scores with the predefined threshold (by the comparator 406). The merging module 408 may further consider the association rules to determine the actual input-output links between stages. The input links and the output links may represent a structured representation of the inferred links between stages, including the stages involved and the fields being transferred. In an aspect, said structured representation a dictionary including each key may be the stage name, and the value may be a list of inferred parent stages (the stages which provide input). Moreover, the merging module 408 may perform exhaustive pairing to identify the input links and the output links for the subset of the plurality of stages. Specifically, the merging module 408 may receive data including the comparison of the scores with the predefined threshold, along with the association rules, from the comparator 406. The association rule may indicate the dependency between a “from” stage and a “to” stage with an associated strength or likelihood. The merging module 408 may iterate through all possible pairs of stages (for example, stage A, stage B) within the data stage file 212. For each pair, the merging module 408 may consider the possibility of direct data flow relationship between said par of stages (for example, either A->B or B->A). For each pair of stage (A, B), the merging module 408 may identify the association rule matching with said pair of stage (A, B). Specifically, the merging module 408 may identify the association rules where the “from” stage corresponds to stage A, and the “to” stage corresponds to stage B. The merging module 408 may, further, identify the association rules where the “from” stage corresponds to stage B, and the “to” stage corresponds to stage A. After the matching association rule is identified for the stage pair (A, B), the merging module 408 may examine the score (e.g., confidence) for with association rule. A higher score may indicate a stronger likelihood of a direct data flow between said pair of stages. Based on the matching rules and the scores, the merging module 408 may infer the parent-child relationships between the stages. If the association rule with the high score indicates “from: stage A, to: stage B”, then stage A may be inferred as a parent (providing input) to stage B. Conversely, if the high-scoring rule indicates “from: stage B, to: stage A”, then stage B may be inferred as the parent to stage A. The stage may have multiple parent stages if multiple high-scoring association rules point the “to” stage from different “from” stages. Consequently, the merging module 408 may generate the final output, including structured representation of the inferred input-output links. The input-output links may include the keys as stage names, and the values as lists of the inferred parent stages.

FIG. 5 illustrates a block diagram representation of the graph generation module 222 for generating the stage graph 510 representing the logical flow in the data stage file 212, in accordance with implementations of the present disclosure. An execution engine 502 in the graph generation module 222 may establish an execution order for the plurality of stages using topological sort. Additionally, the execution engine 502 may identify parent stages for each stage of the plurality of stages based on the execution order. The topological sort may refer to the technique for establishing specific order in which tasks or stages are executed. The execution order may consider the dependencies between stages. By using the topological sort, the execution engine 502 may identify find the valid ordering of the stages based on said dependencies. The stage can only be executed after all of the input dependencies (parent stages input data into the stage) have completed. Moreover, said dependencies may be represented as a directed graph where nodes represent stages and edges represent the dependencies. The execution engine 502 may apply the topological sort to the directed graph to determine the valid execution order for the stages, ensuring that each stage's dependencies are met before it's executed.

In further detail, the execution engine 502 may calculate the in-degree of each node (the number of incoming edges). The execution engine 502 may identify nodes with an in-degree of zero (no dependencies), such nodes may be the starting nodes. The execution engine 502 may then add the starting node to the sorted list followed by removing the node and all the outgoing edges. Further, the execution engine 502 may decrement the in-degree of the neighbors, followed by iteratively identifying nodes with an in-degree of zero (no dependencies), until all nodes are in the sorted list. Moreover, to identify parent stages for each stage of the plurality of stages based on the execution order, the execution engine 502 may identify the parent stages for any given stage as the stages which have outgoing edges.

Further, a feature extraction module 504 may extract features, from the directed graph, including, but not limited to, attribute information, assignment information and metadata from the subset of the plurality of stages. The attribute information may refer to the inherent properties and characteristics of each stage node in the directed graph. The non-limiting examples of the attribute information may include stage type (for example, transformer, join, lookup, source, target, or the like), operator type (specific subtype of the stage, for example, inner join, left outer join within a join stage), configuration parameters (specific settings defined for the stage, for example, file paths, database connection details, buffer sizes, or the like), data types of input/output (the schema of the data flowing into and out of the stage) and transformation logic (the instructions used to manipulate data within the transformer stage). The assignment information may refer to assignment or mapping of the attributes or values within the stage or between connected stages (for example, join keys in join stages, lookup keys in lookup stages, filter conditions in filter stages and aggregation keys and functions in aggregator stages). The metadata may refer to the descriptive information about the stages and the context of overall job defined in the data stage file 212. For example, stage name and description, creation and modification timestamps (that is, information about the stage's lifecycle), project information (that is the data stage project to which the stage belongs), job parameters and variables used (that is contextual elements influencing the stage's behavior) and annotations or comments (that is, additional descriptive text associated with the stage).

In further detail, the feature extraction module 504 may iterate through the nodes (stages) of the input directed graph. For each stage node, feature extraction module 504 may access the stored properties and metadata associated with said stage. Based on the stage type and the properties, the feature extraction module 504 may apply a set of predefined rules to extract relevant attribute information, assignment details, and metadata. For example, if the stage type is “transformer”, the set of predefined rules may be applied to parse and extract the transformation expressions. In another example, if the stage type is “join”, the set of predefined rules may be applied to extract the join keys and join type. Furthermore, the extracted features for each stage are typically organized into a structured format, such as dictionaries, lists, or custom data objects.

Each feature may be labeled with the appropriate name and value. In an example, for the “transformer” stage in the directed graph, the feature extraction module 504 may extract the attribute information expressed as below:
stage_type: “Transformer”, input_link_count: 1, output_link_count: 1
   Moreover, the feature extraction module 504 may extract the assignment information expressed as below:
transformation_rule_1: “OutputColumn1=InputColumnA+1”, transformation_rule_2: “OutputColumnB=trim (InputColumnB)”
   Additionally, the feature extraction module 504 may extract the metadata expressed as below:
stage_name: “Calculate_New_Values”, description: “Adds 1 to InputColumnA and trims InputColumnB”

Further, the extracted features may be analyzed by a context-aware neural network 506, to obtain a classification of the features. The context-aware neural network 506 may analyze the extracted features in relation to the context within the data stage file 212 to categorize variables or parameters used in the stage logic. The output of context-aware neural network 506 may provide classified variables to further enrich the directed graph nodes. Herein, the context-aware neural network 506 may refer to the type of neural network architecture to process sequential or structured data related to the order and relationships. For example, the context-aware neural network 506 may include recurrent neural networks (RNNs). The RNNs may process sequences of features, where the network's internal state can retain information about earlier parts of the sequence, allowing the RNNs to determine the context of the current feature. In the data stage file 212, the sequence of features may represent the attributes and logic within the single stage or the features of stages connected in the data flow. In another example, the context-aware neural network 506 may include graph neural networks (GNNs). If the input features are inherently related by the structure of the directed graph (for example, features of neighboring stages), the GNN may propagate information across the directed graph to learn context-aware representations for each node (stage) and the features. The context-aware neural network 506 may be trained to perform classification of the features. That is, the output layer may include a number of neurons equal to the number of predefined classes or categories. For each input set of features, the context-aware neural network 506 may predict the probability distribution over said predefined classes, and the class with the highest probability may be considered the predicted classification for said features. The output of the context-aware neural network 506 may be the classification (or a set of classifications with associated probabilities) for the input features. For instance. The features may be classified to include variable types (categorizing variables used, for example, input field, output field, intermediate variable, parameter, or the like), operation types (that is, classifying the kind of operation performed in a transformation, for example, string manipulation, arithmetic calculation, date/time processing, data type conversion, or the like), data sensitivity levels (that is, classifying data fields based on the sensitivity, for example, public, confidential, restricted), functional roles of stage components (that is, classifying different parts of the stage's configuration based on the function).

Moreover, the context-aware neural network 506 may utilize techniques such as, sequential processing, attention mechanisms and graph propagation, to obtain the classification of the features. The sequential processing may include processing the features in sequence, thereby identifying the order and relationships between the features. For example, the classification of a variable may depend on the type of stage used and the surrounding expressions. The attention mechanisms may allow the context-aware neural network 506 to weigh the importance of different parts of the input sequence while making the prediction for a specific element, thereby effectively capturing long-range dependencies and contextual relevance. The graph propagation may include exchanging information between connected nodes in the directed graph, thereby enabling the classification of the node's features to be influenced by the properties of the neighbors, thus incorporating structural context.

An enrichment module 508 may receive the directed graph from the execution engine 502, along with the output (including classification of the features) from the context-aware neural network 506. The enrichment module 508 may enrich the nodes of the directed graph with the features. Specifically, the enrichment module 508 may establish mapping between the classified features and the corresponding nodes (stages) or elements within said nodes in the directed graph. The mapping may be implemented by using identifiers or contextual information to associate the output from the context-aware neural network 506 with the correct part of the directed graph. Once the mapping is established, the enrichment module 508 may add the classified features as new attributes or properties to the relevant nodes in the directed graph. For example, if the context-aware neural network 506 classifies the variable within the “transformer” stage's expression as the “input field,” the attribute like variable_type: “input_field” may be added to the node representing said variable within the “transformer” stage's data structure in the directed graph. In another example, if the context-aware neural network 506 classify the operation in the “filter” stage's condition as “comparison,” the attribute like operation_type: “comparison” may be added to the node representing said condition within the “filter” stage in the directed graph. Consequently, the enrichment module 508 may generate the stage graph 510 representing the logical flow, including the nodes and the edges. Herein, the nodes of the stage graph 510 may represent corresponding stages of the plurality of stages and edges of the stage graph 510 connecting the nodes may represent the input links and output links.

FIG. 6 illustrates a block diagram representation 600 of the stage optimization module 224 for optimizing the stage graph 510, in accordance with implementations of the present disclosure. The stage optimization module 224 may include a feature extraction module 602, a normalization module 604 and a community detection module 606. The feature extraction module 602 extract features for each stage (node) in the stage graph 510. The features, as previously described, may include attribute information (e.g., stage type, configuration parameters), assignment information (e.g., mapping rules, join keys), and metadata (e.g., stage name, description). Thereafter, the normalization module 604 may receive the extracted features as input and performs feature normalization. The feature normalization may refer to a preprocessing step for analyzing the features using machine learning techniques. Normalization may scale the values of the extracted features to a standard range (for example, 0 to 1, or to have zero mean and unit variance). Normalization may ensure that the features with different scales proportionately influence subsequent techniques, such as a community detection technique. The non-limiting examples of the normalization techniques may include Min-Max scaling and Z-score standardization. After that, the community detection module 606 may receive the normalized features as input and may apply community detection technique. By utilizing the community detection technique, the community detection module 606 may cluster the enriched nodes of the stage graph 510 using a hierarchical clustering technique, such as a Louvain community detection technique. The hierarchical clustering technique may include identifying groups of nodes densely connected in the stage graph 510. By utilizing the hierarchical clustering technique, the community detection module 606 may identify the densely connected group of nodes based on the similarity of the normalized features. Specifically, the hierarchical clustering technique may include iteratively moving nodes between communities to optimize the modularity of the stage graph 510, which is a measure of the strength of division of the stage graph 510 into communities. Herein, the connections or similarity between the stages may be derived from normalized feature vectors (e.g., using cosine similarity or Euclidean distance). Stages with more similar feature vectors may be considered connected or related for the purpose of community detection. Specifically, each stage may be represented by the normalized feature vector, which may be a list of numbers where each number corresponds to a specific characteristic of the stage. The community detection module 606 may measure the distance/similarity between the stages (normalized feature vector) by using techniques such as cosine similarity or Euclidean distance. The cosine similarity may measure the cosine of the angle between two normalized feature vector. A cosine similarity of 1 may indicate that the normalized feature vector is pointing in the same direction (high similarity), 0 may indicate that the normalized feature vector are orthogonal (no similarity in direction), and −1 may indicate that the normalized feature vector are in opposite directions (high dissimilarity). Furthermore, Euclidean distance may include calculating the straight-line distance between the two normalized feature vector in the multi-dimensional feature space. Smaller distances may indicate higher similarity. In an aspect, a predefined threshold may be applied to the calculated similarity/distance. If the similarity between two stages exceeds the threshold (or the distance is below the threshold), said stages may be considered similar. In essence, the community detection module 606 may output the optimized stage graph 608. The optimized stage graph 608 may include the stages (nodes) clustered into distinct stage clusters or optimal clusters based on the similarity of the extracted and normalized features. Stages within the same cluster may be similar to each other (in terms of their attributes, behavior, or metadata) than the stages in different clusters. The optimal clusters may represent logical units or processing pipelines within the job defined in the data stage file 212.

By the way of an example, the feature extraction module 602 may extract features from the stage graph 510, expressed as below:

```
“node_id”: “data_transformation_node”,
  “operation”: “Data Cleaning”,
  “metadata”: {
    “complexity”: “medium”,
    “time_complexity”: “O(n)”,
    “memory_impact”: “moderate”,
    “code_length”: 150,
    “variable_name”: “cleaned_data”,
    “scope”: “local”,
    “type”: “intermediate_result”,
    “mutability”: “mutable”,
    “semantic_category”: “processed_dataset”
  }
```

The normalization module 604 may normalize the features the feature extraction module 602, expressed as below:

```
{
  ″node_id″: “copy_307
  ″normalized_features″: {
    ″code_length″: 1.0,
    ″complexity_vector″: [0, 0, 1],
    ″operation_type_vector″: [0, 0, 1],
    ″processing_time_normalized″: 1.0
  }
}
```

The said examples may demonstrate that for each stage in the stage graph 510, set of relevant features (both categorical and numerical) may be extracted, capturing aspects of the stage's operation, complexity, size, and other relevant characteristics.

On receiving the normalized features from the normalization module 604, the community detection module 606 may generate the optimized stage graph 608. The optimized stage graph 608 may include optimal clusters identified by using the hierarchical clustering technique (such as Louvain community detection). For example, distinct communities (optimal clusters) (community 1, community 2 and community 3) may be visualized as sub-graphs, expressed as below:

### Community 1:

contains the nodes labeled “Copy_of_DS_SERV_REPO” and “Copy_307”, connected by a direct edges connecting “Copy_of_DS_SERV_REPO” to “Copy_307”, indicating a data flow or dependency.

### Community 2:

Contains the nodes labeled “Jn_Valid_Service” and “STG_CMAD_ST_SERVICE_MDOT,” also connected by a directed edge pointing from “STG_CMAD_ST_SERVICE_MDOT” to “Jn_Valid_Service”, indicating a data flow or dependency.

### Community 3:

Contains four stages: “TRF_CMAD_LAST_UPD_DTTM”, “Remove_Duplicates_309”, “Copy_of_ds_ECL_TRACKING”, and “AD_LAST_UPD_DTTM”
   Contains edges with the following dependencies:
“TRF_CMAD_LAST_UPD_DTTM” to “Remove_Duplicates_309”
“Remove_Duplicates_309” to “Copy_of_ds_ECL_TRACKING”
“AD_LAST_UPD_DTTM” (representing “TRF_CMAD_LAST_UPD_DTTM”) to “Remove_Duplicates_309” (another representation of the same dependency)

In further detail, the stage optimization module 224 may combine the stages of the stage graph 510 into optimal clusters using hierarchical clustering technique based on the factors like instruction length, types, data transformations, and dependencies to optimally combine and cluster the stages and thus generate optimized stage graph 608. The instruction length may refer to number of tokens associated with each stage. The type may refer to functional type of each stage (e.g., transformer, copy, join). The data transformations may refer to the nature of the data manipulation performed by each stage. The dependencies may refer to the data flow relationships between the stages.

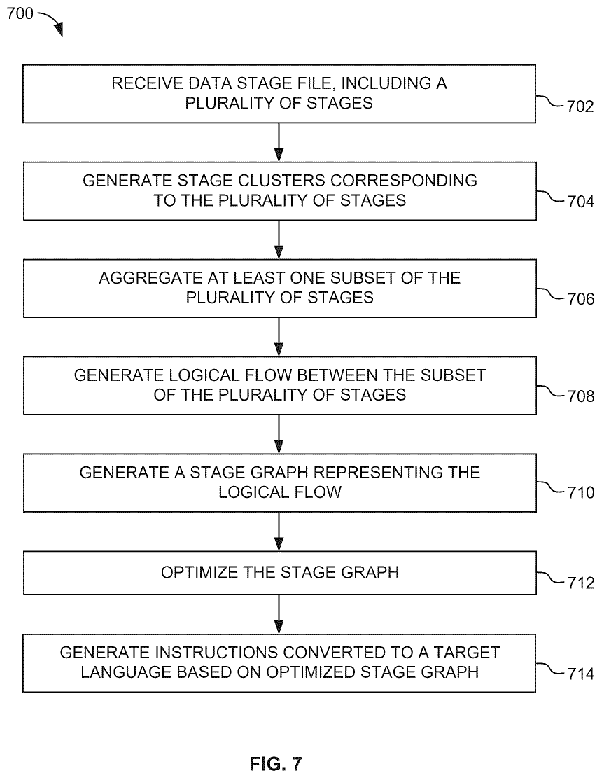

FIG. 7 illustrates a flow diagram of an example processor-executable method 700 for GenAI-based conversion of data stage files 212, the back-end system 106, in accordance with implementations of the present disclosure. In some examples, the processor-executable method 700 may be executed using the one or more processors 204 disclosed in related to FIGS. 1-6.

The processor-executable method 700 may include receiving 702 data stage file 212 regarding the process including the plurality of stages of multiple stage types. Herein, the stage of the plurality of stages may represent the specific operation in the extract, transform, load (ETL) process. Further, receiving 702 the data stage file 212 may include identifying stage names of the plurality of stages and the plurality of stages corresponding to the stage names. The data stage file 212 may be the script file including information regarding the process including user interface (UI) components, metadata, the plurality of stages, logic corresponding to the plurality of stages and the input links and the output links connecting the plurality of stages.

The processor-executable method 700 may include generating 704, using entities output by the foundation model 304, stage clusters 310 corresponding to the plurality of stages. Herein, the entities may be the output by the foundation model 304 in response to receiving the data stage file 212 as input. Specifically, to generate the stage clusters 310, features including structural features and semantic features may be extracted from the data stage file 212 and input the structural features and the semantic features to the foundation model 304. The stage segmentation module 216 may obtain embeddings by transforming the entities output by the foundation model 304 in response to inputting the structural features and semantic features and consequently clustering the embeddings into the stage clusters 310.

The processor-executable method 700 may include aggregating 706 at least one subset of the plurality of stages in the received data stage file 212 corresponding to the transformation stage type of the multiple stage types. Specifically, the stage detection module 218 may classify, by the transformer-based classification model, the plurality of stages into the multiple stage types and identify the transformation stage type of the multiple stage types.

The processor-executable method 700 may include generating 708 from the output of the data mining model 404, logical flow including input links and output links between the subset of the plurality of stages. Herein, the data mining model 404 may provide the output in response to receiving the at least one subset of the plurality of stages as input. Specifically, the dependency mapping module 220 may obtain, as the output of the data mining model 404, the plurality of metrics for different combinations of the subset of the plurality of stage. Further, the dependency mapping module 220 may score each of the combinations of the subset of the plurality of stages based on the plurality of metrics and then may compare the scores corresponding to each combination of the subset of the plurality of stages with the predefined threshold. Consequently, the dependency mapping module 220 may identify the input links and the output links for the subset of the plurality of stages based on the comparison of the scores with the predefined threshold.

The processor-executable method 700 may include generating 710 the stage graph 510 representing the logical flow. Herein, the nodes of the stage graph 510 may represent corresponding stages of the plurality of stages and edges of the stage graph 510 connecting the nodes represent the input links and output links. Further, to generate the stage graph 510, the graph generation module 222 may establish the execution order for the plurality of stages using topological sort and identify parent stages for each stage of the plurality of stages based on the execution order. Moreover, the nodes of the directed graph may be enriched with the features. Herein, the directed graph may be generated as a result of establishment of the execution order for the plurality of stages using topological sort.

The processor-executable method 700 may include optimizing 712 the stage graph 510 by clustering the nodes based on predetermined factors. The enriched nodes of the stage graph 510 may be clustered using hierarchical clustering technique to generate the optimized stage graph 608.

The processor-executable method 700 may include generating 714 instructions converted to the target language (for example, sparkSQL) by providing the optimized stage graph 608 as a prompt to the Large Language Model (LLM). The LLM may be fine-tuned on domain-specific examples for accurate conversion.

Implementations of the present disclosure provide technical advancements in the context of conversion of data stage files 212. For example, the present disclosure, unlike the traditional methods which directly interpret a compiled or internal data stage files 212, the file ingestion module 214 may analyze and process data stage file 212 which explicitly describes all aspects of the data stage job. The file ingestion module 214 may reconstruct the data stage file's 212 structure, metadata, processing logic within each stage, and the data flow between plurality of stages. The approach may provide advantages like easier version control, portability (if the script format is standardized), and potentially simpler initial analysis compared to reverse-engineering a complex binary format in the traditional methods.

Moreover, in the present disclosure, the foundation model 304 may may identify the syntactic structure of the data stage file 212 and extracts the underlying meaning in the form of structured entities. The entities may then provide the stage segmentation module 216 with the necessary information to analyze and group the stages of the data stage process in a meaningful way. Additionally, the feature extraction module 302 may serve as an intelligent analyzer which may dissects the data stage file 212 into the fundamental components and the associated meanings (that is structural and semantic features). The feature extraction module 302 may utilize the combination of rule-based techniques for structural aspects and a foundation model 304 for determining the complex semantic aspects of the logic defined in the data stage file 212.

Furthermore, the dependency mapping module 220 by utilizing machine learning techniques may score each of the combinations of the subset of the plurality of stage, enabling the back-end system 106 to prioritize stronger and more frequent relationships discovered by the data mining model 404, leading to more accurate and reliable automated dependency and logical flow mapping. Additionally, unlike the traditional methods which solely analyze the explicitly defined input links and the output links within the data stage file 212, in the present disclosure, dependency mapping module 220, may implement exhaustive pairing based on association rule mining to identify implicit data flow relationships between the stages. Exhaustive pairing, by analyzing patterns, may infer the logical flow even in cases where the explicit connections are intricate or change frequently. Exhaustive pairing further indirect dependencies facilitating the broader data processing context. In essence, the technical advantage of exhaustive pairing lies in its ability to automatically and objectively infer the logical data flow in data stage file 212 by leveraging data-driven patterns, providing a more comprehensive and scalable solution compared to traditional methods including manual analysis or relying solely on explicit data structures.

Moreover, in the present disclosure, the context-aware neural network 506 may receive the extracted features as input and, by leveraging its architecture and learned patterns from training data, provides a classification for each feature, taking into account the surrounding context within the data stage file 212 structure and logic. This classification enriches the identification of the individual components and their roles within the overall data processing workflow.

In the present disclosure, enrichment module 508, by enriching the nodes (in the directed graph) with classified features (obtained from the context-aware neural network 506) may create semantically rich and informative representation of the data stage file 212. Thus, the directed graph may include the structure and data flow in addition to incorporation of insights into the nature and function of the elements within each stage in the data stage file 212. In further detail, the stage optimization module 224 by identifying optimal stage clusters 310, then apply targeted optimization strategies to each stage cluster, thereby potentially improving the overall performance, efficiency, or maintainability of the data stage file 212 workflow. For example, stages within the same cluster may perform parallelization, script consolidation, or resource tuning.

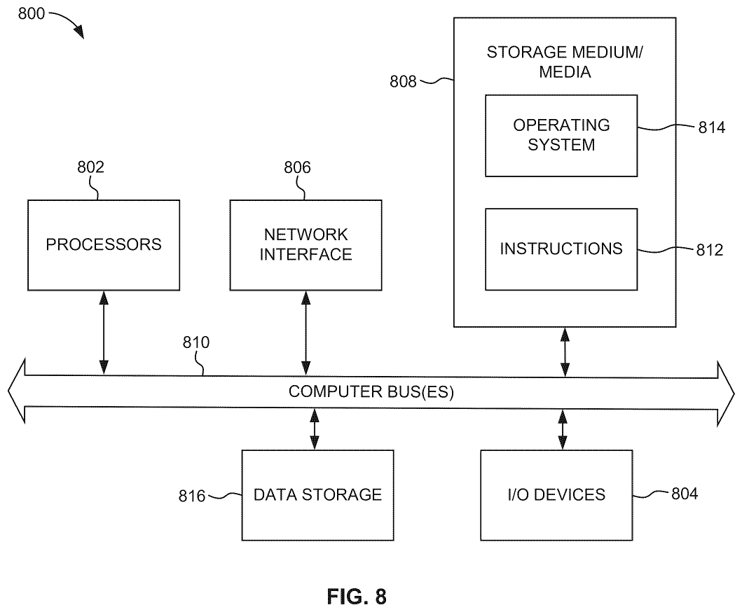

FIG. 8 illustrates a computer system 800 that may be used to implement the back-end system 106 disclosed in the example environment of FIG. 1. for conversion of data stage files 212, in accordance with implementations of the present disclosure. More particularly, computing machines such as desktops, laptops, smartphones, tablets, and wearables which may be used to implement the tasks that may have the structure of the computer system 800. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802, such as a central processing unit, ASIC or another type of processing circuit, input/output devices 804, such as a display, mouse keyboard, etc., a network interface 806, such as a Local Area Network (LAN), a wireless 502.11x LAN, a 3G or 4G mobile WAN or a WiMax WAN, and a computer-readable medium 808. Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium, such as a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the system for GenAI-based conversion of data stage files 212.

The system may be implemented as software stored on a non-transitory processor-readable medium and executed by the processors 802. For example, the computer-readable medium 808 may store an operating system 814, such as MAC OS, MS WINDOWS, UNIX, or LINUX, and code for the system. The operating system 814 may be multi-user, multiprocessing, multitasking, multithreading, real-time, and the like. For example, during runtime, the operating system 814 is running and the code for the system is executed by the processor(s) 802.

The computer system 800 may include a data storage 816, which may include non-volatile data storage. The data storage 816 stores any data used or generated by the system.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network

(LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A system for converting a data stage file to a target language, comprising:
at least one hardware processor; and
at least one non-transitory processor-readable medium storing instructions to be executed by the at least one hardware processor to:
receive, from a data source, the data stage file regarding a process including a plurality of stages of multiple stage types, wherein a stage of the plurality of stages represents a specific operation in an extract, transform, load (ETL) process;
extract features including structural features and semantic features from the received data stage file;
receive the structural features and the semantic features as input to a foundation model stored in a model database;
train the foundation model with the structural features and the semantic features to identify a plurality of entities based on patterns and relationships present in the structural and the semantic features;
output, the plurality of entities by the trained foundation model in response to receiving the structural features and the semantic features;
obtain a plurality of embeddings by transforming the plurality of entities output by the trained foundation model in response to inputting the structural features and the semantic features;
cluster the obtained embeddings into stage clusters by using a machine learning model stored in the model database, wherein the stage clusters are generated by aggregating two or more entities of the plurality of entities based on similarity between two embeddings of the plurality of the embeddings;
aggregate at least one subset of the plurality of stages in the received data stage file, from the stage clusters, corresponding to a transformation stage type of the multiple stage types;
generate, by using a data mining model, logical flow comprising input links and output links between the subset of the plurality of stages,
wherein the data mining model provides the output in response to receiving the at least one subset of the plurality of stages as input;
generate a stage graph representing the logical flow, wherein nodes of the stage graph represent corresponding stages of the plurality of stages and edges of the stage graph connecting the nodes represent the input links and output links;
optimize the stage graph by clustering the nodes based on predetermined factors;
generate instructions converted to the target language by providing the optimized stage graph as a prompt to a Large Language Model (LLM); and
output, using the LLM, a translation of the optimized stage graph into the target language.

2. The system of claim 1, wherein the data stage file is a script file including information regarding the process including user interface (UI) components, metadata, the plurality of stages, logic corresponding to the plurality of stages.

3-5. (canceled)

6. The system of claim 1, wherein to aggregate at least one subset of the plurality of stages, non-transitory processor-readable medium further stores instructions that cause the processor to:
classify, by a transformer-based classification model, the plurality of stages into the multiple stage types; and
identify the transformation stage type of the multiple stage types.

7. The system of claim 1, wherein to generate the logical flow including the input links and the output links, the non-transitory processor-readable medium further stores instructions that cause the processor to:
obtain, as the output of the data mining model, a plurality of metrics for different combinations of the subset of the plurality of stages;
score each of the combinations of the subset of the plurality of stages based on the plurality of metrics; and
compare the scores corresponding to each combination of the subset of the plurality of stages with a predefined threshold.

8. The system of claim 7, wherein to generate the logical flow including the input links and the output links, the non-transitory processor-readable medium further stores instructions that cause the processor to:
identify the input links and the output links for the subset of the plurality of stages based on the comparison of the scores with the predefined threshold.

9. The system of claim 1, wherein to generate the stage graph representing the logical flow including the input links and the output links, the non-transitory processor-readable medium further stores instructions that cause the processor to
configure the plurality of stages to execute in an order determined based on a topological sort; and
identify parent stages for each stage of the plurality of stages based on the execution order.

10. The system of claim 9, wherein to generate the stage graph representing the logical flow including the input links and the output links, the non-transitory processor-readable medium further stores instructions that cause the processor to:
extract features including attribute information, assignment information and metadata from the subset of the plurality of stages; and
obtain a classification of the features from a context-aware neural network.

11. The system of claim 10, wherein to generate the stage graph representing the logical flow including the input links and the output links, the non-transitory processor-readable medium further stores instructions that cause the processor to:
enrich the nodes of a directed graph with the features, wherein the directed graph is generated on configuring the plurality of stages in accordance with the execution order based on the topological sort.

12. The system of claim 11, wherein to optimize the stage graph, the non-transitory processor-readable medium further stores instructions that cause the processor to:
cluster the enriched nodes of the stage graph using a hierarchical clustering technique.

13. The system of claim 11, wherein to receive the converted instructions from the LLM, the non-transitory processor-readable medium further stores instructions that cause the processor to:
fine tune the LLM by setting hyperparameters on domain-specific dataset for accurate conversion.

14. A processor-executable method for converting a data stage file to a target language, comprising:
receiving, by a processor, from a data source the data stage file regarding a process including a plurality of stages of multiple stage types, wherein a stage represents a specific operation in an extract, transform, load (ETL) process;
extracting, by the processor, features including structural features and semantic features from the received data stage file;
receiving, by the processor, the structural features and the semantic features as input to a foundation model stored in a model database;
training, by the processor, the foundation model with the structural features and the semantic features to identify a plurality of entities based on patterns and relationships present in the structural and the semantic features;
outputting, by the processor, the plurality of entities by the trained foundation model in response to receiving the structural features and the semantic features;
obtaining, by the processor, a plurality of embeddings by transforming the plurality of entities output by the trained foundation model in response to inputting the structural features and the semantic features;
clustering, by the processor, the obtained embeddings into stage clusters by using a machine learning model stored in the model database, wherein the stage clusters are generated by aggregating two or more entities of the plurality of entities based on similarity between two embeddings of the plurality of the embeddings;
aggregating, by the processor, at least one subset of the plurality of stages in the received data stage file, from the stage clusters, corresponding to a transformation stage type of the multiple stage types;
generating, by the processor, by using a data mining model, logical flow comprising input links and output links between the subset of the plurality of stages,
wherein the data mining model provides the output in response to receiving the at least one subset of the plurality of stages as input;
generating, by the processor, a stage graph representing the logical flow wherein nodes of the stage graph represent corresponding stages of the plurality of stages and edges of the stage graph connecting the nodes represent the input links and output links;
optimizing, by the processor, the stage graph by clustering the nodes based on predetermined factors;
generating, by the processor, instructions converted to the target language by providing the optimized stage graph as a prompt to a Large Language Model (LLM); and
outputting, by the processor, using the LLM, a translation of the optimized stage graph into the target language.

15. The processor-executable method of claim 14, wherein receiving the data stage file regarding the process, further comprises:
identifying, by the processor, stage names of the plurality of stages; and
extracting, by the processor, the plurality of stages corresponding to the stage names.

16. The processor-executable method of claim 14, wherein aggregating the subset of the plurality of stages, further comprises:
classifying, by the processor via a transformer-based classification model, the plurality of stages into the multiple stage types; and
identifying the transformation stage type of the multiple stage types

17. The processor-executable method of claim 14, further comprising:
configuring, by the processor, the subset of the plurality of stages to execute in an order determined by topological sorting.

18. A non-transitory processor-readable storage medium comprising machine-readable instructions that cause a processor to:
receive, from a data source, a data stage file regarding a process including a plurality of stages of multiple stage types, wherein a stage represents a specific operation in an extract, transform, load (ETL) process;
extract features including structural features and semantic features from the received data stage file;
receive the structural features and the semantic features as input to a foundation model stored in a model database;
train the foundation model with the structural features and the semantic features to identify a plurality of entities based on patterns and relationships present in the structural and the semantic features;
output, the plurality of entities by the trained foundation model in response to receiving the structural features and the semantic features;
obtain a plurality of embeddings by transforming the plurality of entities output by the trained foundation model in response to inputting the structural features and the semantic features;
cluster the obtained embeddings into stage clusters by using a machine learning model stored in the model database, wherein the stage clusters are generated by aggregating two or more entities of the plurality of entities based on similarity between two embeddings of the plurality of the embeddings;
aggregate at least one subset of the plurality of stages in the received data stage file, from the stage clusters corresponding to a transformation stage type of the multiple stage types;
generate from an output of a data mining model, logical flow including input links and output links between the subset of the plurality of stages,
wherein the data mining model provides the output in response to receiving the subset of the plurality of stages as input;
generate a stage graph representing the logical flow wherein nodes of the stage graph represent corresponding stages of the plurality of stages and edges of the stage graph connecting the nodes represent the input links and output links;
optimize the stage graph by clustering the nodes based on predetermined factors;
generate instructions converted to the target language by providing the optimized stage graph as a prompt to a Large Language Model (LLM); and
output, using the LLM, a translation of the optimized stage graph into the target language.

19. The non-transitory processor-readable storage medium of claim 18, wherein the foundation model is a deep learning model trained for domain-based named entity recognition.

20. The non-transitory processor-readable storage medium of claim 18, wherein receiving the data stage file regarding the process, further comprises:
identifying, by the processor, stage names of the plurality of stages; and
extracting, by the processor via applying the foundation model, the plurality of stages corresponding to the stage names.

21. The system of claim 11, wherein to enrich the nodes of a directed graph with the features, the non-transitory processor-readable medium further stores instructions that cause the processor to configure to:
map the classified features and corresponding nodes in the directed graph, wherein the mapping is implemented by using identifiers or contextual information to associate an output from the context-aware neural network with a correct part of the directed graph.

22. The system of claim 12, wherein to cluster the enriched nodes of the stage graph using the hierarchical clustering technique, the non-transitory processor-readable medium further stores instructions that cause the processor to:
combine the stages of the stage graph into optimal clusters using the hierarchical clustering technique based on factors like instruction length, types, data transformations, and dependencies to optimally combine and cluster the stages and thus generate optimized stage graph.

23. The system of claim 1, wherein to generate instructions converted to the target language by providing the optimized stage graph as the prompt, the non-transitory processor-readable medium further stories instructions that cause the processor to:
transmit the optimized stage graph as the prompt to an Application Programming Interface (API) endpoint of the LLM in the model database.
